(19) United States
(12) Patent Application Publication
(10) Pub. No.: US 2012/0049024 A1
(43) Pub. Date: Mar. 1, 2012

(54) WALL QUICK MOUNTING DEVICE

(76) Inventor: Benjamin J. SMITH, Las Vegas, NV (US)

(21) Appl. No.: 12/872,169

(22) Filed: Aug. 31, 2010

(51) Int. Cl. F16M 13/02

(52) U.S. Cl. 248/222.14

(57) ABSTRACT

A quick mounting device for appliances that is quickly and easily engaged and disengaged mechanically and electrically without the use of tools.

### CROSS-REFERENCE TO RELATED APPLICATIONS

This non-provisional utility patent application claims the benefit of prior filed U.S. provisional application Ser. No. 61/269,962 filed Jan. 19, 2010, which is incorporated herein by reference in its entirety.

### BACKGROUND OF THE INVENTION

1. Field of the Invention

The present invention relates to mounting devices in general and particularly to appliance mounting devices allowing quick connection and mounting of electrical appliances at electrical outlets.

2. Description of the Prior Art

There are numerous mechanical, electronic and electro-mechanical devices that require mounting on a surface such as a ceiling, wall or other surface. Typically the devices require a strong mechanical attachment to the ceiling, wall or other surface while at the same time requiring an electrical connection to power typically supplied by wiring in the ceiling, wall or other surface. Such devices include but are not limited to: ceiling fans, chandeliers and other lighting fixtures, hanging retractable power shop tools/devices, televisions (tubes, flat screens, plasma, etc.), projectors, speakers, cameras, fire/smoke/heat/gas detectors, garage door openers, microwave ovens, cabinets and numerous other hanging fixtures.

U.S. Pat. No. 6,093,044 issued Jul. 25, 2000 and assigned to Pelco for a quick connect/disconnect mechanism describes a latch and catch quick connect/disconnect mechanism for mechanically mounting an electric or electronic device within a receptacle box or housing.

U.S. Pat. No. 6,042,068 issued Mar. 28, 2000 and assigned to Peerless Industries Inc for a low profile LCD projector mount describes a low profile projector mount having an upper element attached to the ceiling with slide guides projecting from its bottom surface and a lower element attached to the projector with flanges in slideable engagement with the guides. The upper element further has a spring-based latching mechanism.

U.S. Pat. No. 6,857,903 issued Feb. 22, 2005; U.S. Pat. No. 6,376,770 issued Apr. 23, 2002; U.S. Pub. No. 2005/0126813 published Jun. 16, 2005 & U.S. Pub. No. 2003/0124905 published Jul. 3, 2003 assigned to Eclectic Limited for a quick connecting universal electrical box and wiring system describes a quick connecting universal electrical box mounting system for the installation of electrical sockets, switches or any electronic component that is typically installed into a wall for users to access.

U.S. Pat. No. 4,403,278 issued Sep. 6, 1983 and assigned to Harvstone Manufacturing Corporation for a mounting system for suspended lighting fixtures describes a quick mounting system for suspended light fixtures, including a box which is open at one side and a plate dimensioned to cover the opening, a disengagable pivot positioned at one end of the box and plate, and a hooking means at the opposite end of the box and plate.

U.S. Pat. No. 7,201,354 issued Apr. 10, 2007 and assigned to KTV, USA Inc. for a video monitor mounting system describes a video monitor mounting system for use in conjunction with seat back, head restraint or roof mount applications. It includes a mounting tray fixed in a hollowed out socket formed in a seat back, the rear face of a head restraint or within a roof mount overhead console.

U.S. Pat. No. 3,693,921 issued Sep. 1972 and assigned to the United States of America as represented by the Navy for a quick release mounting apparatus describes an apparatus for stable mounting of a device, such as a TV camera, to an underwater support, and which can be easily and quickly locked or unlocked from the support by manipulation of a lever.

U.S. Pat. No. 6,634,901 issued Oct. 21, 2003; U.S. Pat. No. 6,503,099 issued Jan. 7, 2003; & U.S. Pat. No. 6,799,982 issued Oct. 5, 2004 assigned to Angelo Fan Brace Licensing LLC for a quick connect device for electrical fixture describes a quick-connect device for hanging fans, lighting fixtures, and the like. A horizontal sliding connector is provided between the ceiling box and the electrical fixture to take the weight of the fixture as it is inserted.

U.S. Pat. No. 6,676,442 issued Jan. 13, 2004 and assigned to Angelo Fan Brace Licensing LLC for a quick connect device with easy installation features including plug and spring describes a quick-connect device for hanging fans, lighting fixtures, and the like.

U.S. Pat. No. 7,160,148 issued Jan. 9, 2007; U.S. Pat. No. 6,997,740 issued Feb. 14, 2006; U.S. Pub No. 2002/0111063 published Aug. 15, 2002 & U.S. Pub No. 2005/0272306 published Dec. 8, 2005 and assigned to Angelo Fan Brace Licensing LLC for a ceiling fixture with easy installation features describes a quick connect device for electrically and physically mounting the fan to a ceiling.

U.S. Pat. No. 3,798,584 issued Mar. 1974 for a quick connect ceiling electrical fixture mounting describes a quick connect mounting for connecting an electrical fixture to a conventional outlet box positioned within a ceiling. An electrical fixture may be readily plugged into the ceiling and removed therefrom in the same manner as a conventional electrical plug is inserted into and withdrawn from a wall outlet.

U.S. Pat. No. 7,175,152 issued Feb. 13, 2007 and assigned to CSAV Inc. for a display mounting device describes a flat panel display mounting apparatus that enables quick and easy mounting and dismounting of the flat panel display.

U.S. Pat. No. 4,645,286 issued Feb. 24, 1987 and assigned to Elliot Isban for a quick connect power tap system describes a coupling system which allows for quickly changing electrical fixtures without rewiring.

U.S. Pat. No. 4,645,289 issued Feb. 24, 1987 to inventor Elliot Isban for a quick connect power tap system describes an improvement to U.S. Pat. No. 4,645,286 (described above).

U.S. Pub. No. 20090280673 published Nov. 12, 2009 for a quick connect assembly; U.S. Pub. No. 20070167072 published Jul. 19, 2007 for a quick connect device for electrical fixtures and U.S. Pub. No. 20050148241 published Jul. 7, 2005 for a quick connect device for electrical fixtures describe a device for quick connecting and supporting fixtures, such as electrical fixtures.

### SUMMARY OF THE INVENTION

The present invention relates to a system for quickly mounting appliances to support structures.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a side view of one embodiment of the invention. (Inventor's file 1).

FIG. 2 is a detailed side view of the top of one embodiment of the invention. (Inventor's file 2).

FIG. 3 is front view of one embodiment of the invention. (Inventor's file 3).

FIG. 4 is a back view of one embodiment of the invention. (Inventor's file 4).

FIG. 5 is a perspective view of the front assembly of one embodiment of the invention. (Inventor's file 5).

FIG. 6 is a side view of the latching mechanism.

FIG. 7 is a perspective view of an example installation of the present invention.

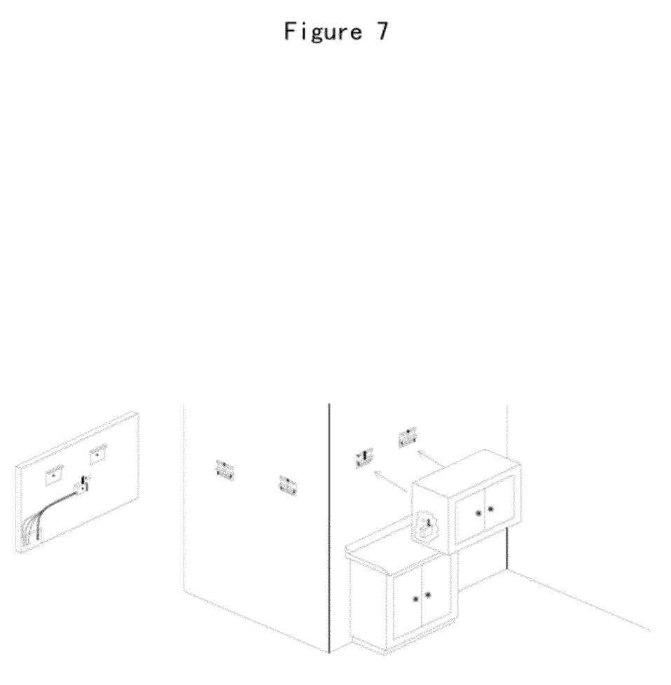

### DETAILED DESCRIPTION

The problems associated with the current methods of attaching such devices are numerous and include issues of safety, time and convenience. Current methods and devices for attachment require the simultaneous or near simultaneous connection of electrical connections and mechanical support attachments all while typically balancing on a ladder and using dangerous powered or unpowered tools. Current methods and devices are time-consuming; requiring different mechanical and electrical connections with each device—the majority of which are not user friendly. Many consumers must resort to the expense of a professional installer or handyman to make the required electrical and mechanical connections.

Disclosed herein is a quick mounting system that mounts electric, electronic, mechanical and electro-mechanical devices to a ceiling, wall or other surfaces that addresses the above needs and deficiencies of current methods and devices. This mounting system can be used virtually anywhere a device or an object needs to be installed off the ground without the use of tools. The manually operated locking mechanism enables one to quickly and permanently lock the device/object in place by human hand as well as unlock it without the use of any tools. The quick mounting system may be used to attach/mount electrical, electronic, and mechanical devices with or without power as well as other objects that need to be mounted on walls, ceilings or other surfaces.

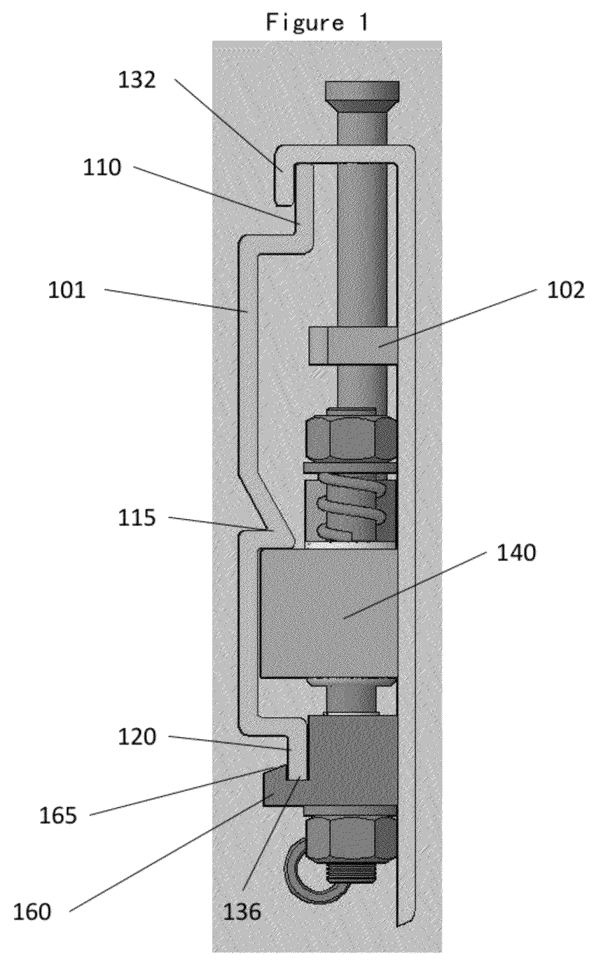

Referring now to the drawings in general, the illustrations are for the purpose of describing a preferred embodiment of the invention and are not intended to limit the invention thereto. With reference to the figures, only FIG. 1 shows the electrical connectors in place on the quick mount system. The engineering drawings and photographs do not show the electrical connector. However, the electrical connector would generally be located through the center of the top and back plates of the quick mount system. The dimensions, specifications, materials and other call outs on the engineering drawings are representative only and not critical to the quick mount system. Other dimensions, specifications, materials and call outs are within the scope of the invention disclosed herein.

With reference to FIG. 1, in one embodiment described herein, the quick mount system includes a back plate 101 and a front assembly 102. The plates and main components of the device may be manufactured from mild steel. However, the device may be manufactured of any material that has the requisite strength and impact properties that may vary according to the type of apparatus the mounting device is designed to mount. A male electrical connector (not shown) can be included in the front assembly. The back plate 101 includes a female electrical connector (not shown) designed to mate with the male electrical connector. In some embodiments, the connectors could be reversed, that is to say, the male connector may be housed in the back plate and the female connector housed in the front assembly. In either case, the male and female connectors are preferably located substantially through the center of the back plate and front assemblies but in any event in such manner so that when the plates are brought together as intended by the invention the male and female electrical connectors mate so as to form an electrical connection. The electrical connectors are preferably low profile, rear-mounting connectors but may be of other designs as well.

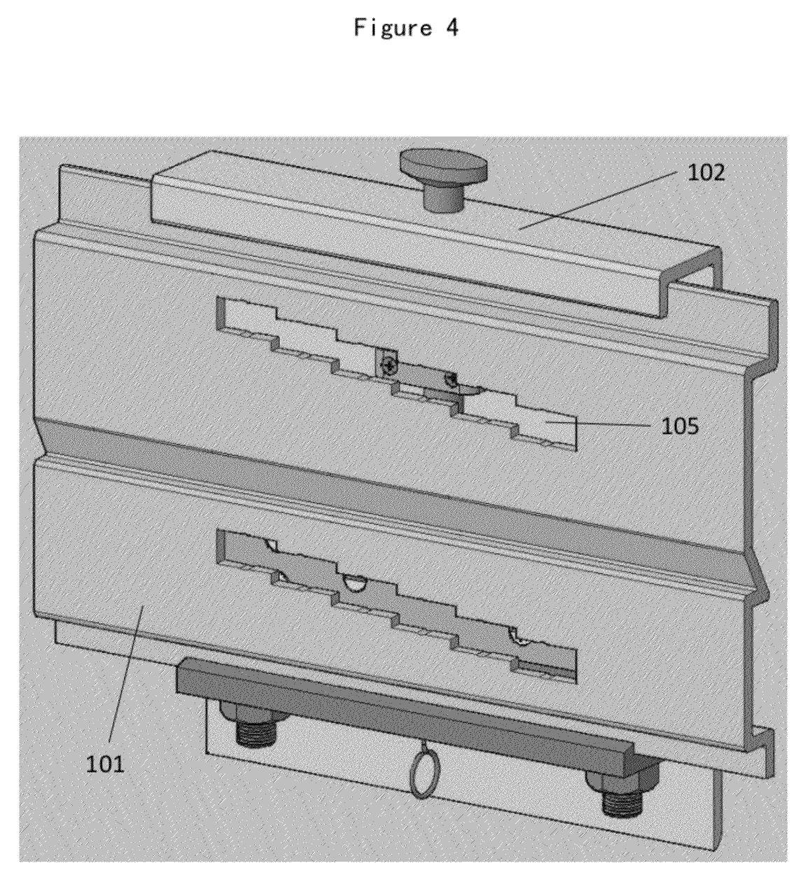

FIG. 4 shows the back plate in detail. The back plate 101 would be attached to the wall, ceiling or other surface via the mounting slots 105. The optional electrical connector (not shown) in the back plate 101 is connected to the power or other electrical supply in the wall, ceiling or other surface.

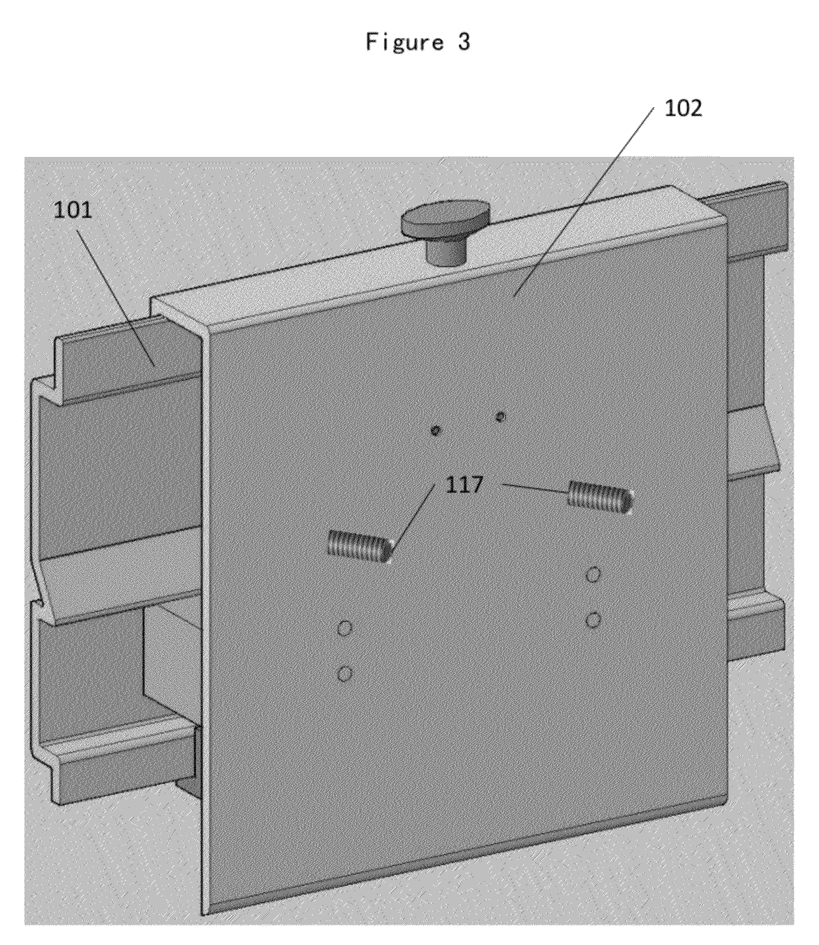

FIGS. 1, 2, 3 and 5 show the front assembly 102 and its components. The front assembly 102 is attached to the device to be mounted (e.g., ceiling fan, flat screen TV, cabinet, etc.) via the special bolts 117 (shown in FIG. 3) and the electrical connector (not shown) in the front assembly 102 is connected to the power requirements of the device to be mounted. Once the back plate 101 is attached to the ceiling, wall or other surface and the front assembly 102 is attached to the device to be mounted on the ceiling, wall or other surface, the front assembly 102 and the back plate 101 are brought together and a mechanical and electrical connection is securely made as described below.

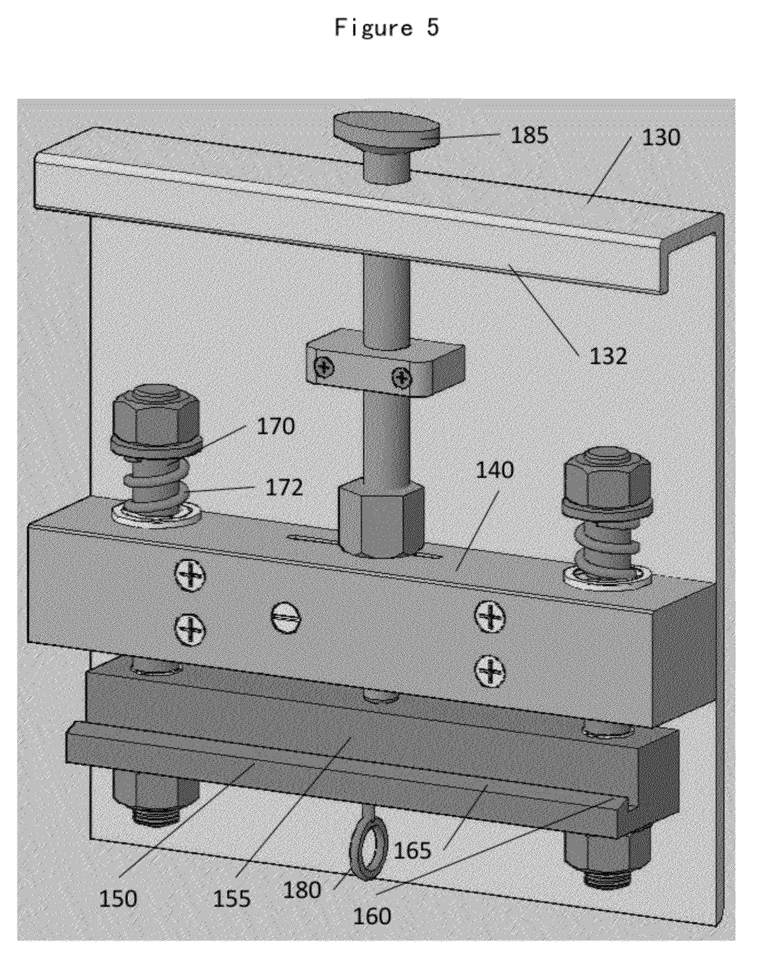

With reference to FIG. 1, the back plate includes a top lip 110, a locking angle 115, and a bottom lip 120. With reference to FIGS. 5, the front assembly includes a plate 130 with top retaining lip 132, a locking bar 140 and a retaining assembly 150.

The locking bar 140 prevents the front assembly from rising vertically when attached to the back plate by being appropriately positioned under the locking angle 115 of the back plate. The locking bar 140 is fastened to the front plate 130 in the appropriate position by appropriate fasteners.

As shown in FIG. 5, the bottom retaining assembly includes a latching bar 155 with a bottom retaining lip 160 that includes a beveled edge 165, guide bolts 170, and retaining springs 172. The bottom retaining assembly further include a bottom pull ring 180 and/or a top push rod 185.

The latching bar is fastened to the guide bolts. The guide bolts are positioned to slide through the support bar in order to permit the latching bar to slide toward and away from the support bar. The latching bar is retained toward the support bar by the retaining springs. The bottom pull ring and, optionally, the top push rod, when activated, move the latching bar away from the support bar.

To use the quick mount device, the user attaches the back plate to the wall, ceiling or other surface by using screws, bolts or other suitable attachment means through the mounting slots 105. If electric power to the device is required, the user may also connect the electrical connector in the back plate to a power supply. The user then attaches the front assembly 102 to the device to be mounted (ceiling fan, etc.) via the special bolts 117. If electrical power is required, the user connects the electrical connector in the front assembly 102 to the power leads of the device to be mounted.

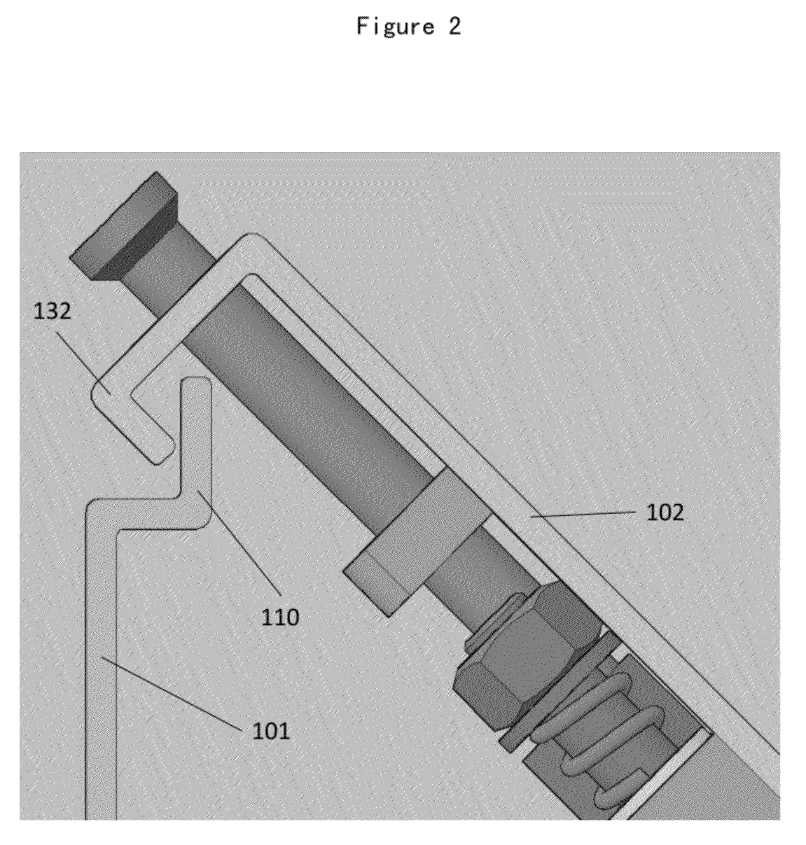

Next, with reference to FIGS. 1 and 2, the top retaining lip 132 of the front assembly is positioned over and slid down onto the top lip 110 of the back plate. The front assembly with appliance is then pivoted toward the back plate in order to bring the bottom retaining lip 160 of the latching bar into juxtaposition with the bottom lip 120 of the back plate (see FIG. 1). The beveled edge 165 of the bottom retaining lip causes the bottom retaining assembly 150 to lower as pressure is applied to the beveled edge. Once the bottom lip 120 has moved past the bottom retaining lip 160 and into the latching groove 136, the bottom latching bar, under pressure from the retaining springs 172, moves toward the locking bar 140, thereby latching the bottom lip with the bottom retaining lip, and thus the front assembly and appliance to the back plate.

At that point, there is a mechanical connection between the back plate 101, which is connected to the wall, and the front assembly 102, which is connected to the device desired to be mounted on the wall as well as an electrical connection between the device and the power supply in the wall. Thus, the device is mechanically connected to the wall, ceiling or other surface and optionally connected with the desired power supply.

To detach the appliance from the support, the pull ring or push rod is activated, releasing the front assembly from back plate. The appliance is then rotated away from the back plate and slid away from the top retaining edge, such that the top retaining lip 132 is no longer holding the top lip 110. The appliance is then free to be moved away from the back plate.

Thus, merely by lifting the device into place and pushing it toward the back plate, the device is attached, without the use of tools, to the back plate and thus the ceiling or wall or other support. Absent the quick mount device, the user would have to lift the device into place and use one arm/hand to hold the device in place while using some sort of tool with the other arm/hand to secure the device to the ceiling or wall. Instead, the quick mounting device frees up both of the user's arm/hands to further secure the device without tools to the ceiling or wall.

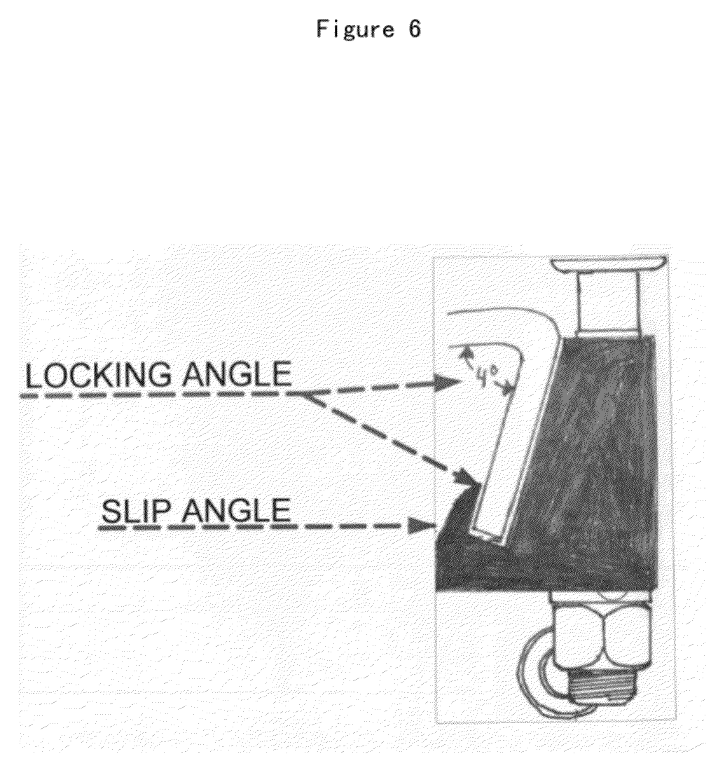

As shown in FIG. 6, the bottom lip includes a locking angle of about 40 degrees and the beveled edge of the bottom retaining lip is about the same angle to facilitate the sliding of the latching bar down as pressure is applied.

While the examples have shown the use of a single mounting device, it is possible to use a multiplicity of devices to mount heavier appliances. For example, cabinets can be mounted to walls using two mounting devices. The front and back components of two devices would first be attached in a level manner to the support and to the cabinet, respectively, and then the cabinet mounted on the support.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

What is claimed is:

1. A quick mounting device for appliances, comprising a back plate and a front assembly,
a. the back plate comprising a top lip, a locking angle and a bottom lip;
b. the front assembly comprising a plate with a top retaining lip, a locking bar and a bottom retaining assembly comprising a latching bar with a bottom retaining lip, guide bolts, retaining springs and pull ring; the latching bar, guide bolts, and retaining springs positioned to allow the latching bar to slide toward and away from the support beam and retained toward the support beam by the springs;
c. the pull ring positioned to slide the latching bar away from the support beam when the pull ring is pulled;
d. the back plate fastenable to an appliance and the front assembly fastenable to a support;
thereby providing a mounting device that is mounted and dismounted quickly and without tools.

2. The device of claim 1, further including an electrical connection.

3. The device of claim 1, further including a push rod positioned to slide the latching bar away from the support beam when the push rod is pushed.
